(19) United States
(12) Patent Application Publication
(10) Pub. No.: US 2004/0109185 A1
(43) Pub. Date: Jun. 10, 2004

(54) Tetrahedral interpolation

(76) Inventors: Ching-Yu Hung, Plano, TX (US); Deependra Talla, Dallas, TX (US)

Correspondence Address: TEXAS INSTRUMENTS INCORPORATED, P O BOX 655474, M/S 3999, DALLAS, TX, 75265

(21) Appl. No.: 10/692,154

(22) Filed: Oct. 22, 2003

Related U.S. Application Data
(60) Provisional application No. 60/420,319, filed on Oct. 22, 2002.

(51) Int. Cl. H04N 1/60; G06T 1/20

(52) U.S. Cl. 358/1.9; 358/518; 358/523; 358/525; 382/162; 382/304

(57) ABSTRACT

Tetrahedral interpolation by rewriting the interpolation in terms of ordered differentials and color differences to lower the computational complexity. Additionally, hardward architecture allows efficient implementation.

### CROSS-REFERENCE TO RELATED APPLICATIONS

This application claims priority from provisional application No. 60/420,319, filed Oct. 22, 2002.

### BACKGROUND OF THE INVENTION

The present invention relates to digital signal processing, and more particularly to interpolation methods and implementation apparatus.

Computer systems usually represent color images to be displayed on a CRT or LCD as a triplet of additive primary color intensities for each pixel. That is, the red, green, and blue (RGB) intensities for each pixel provide the inputs to the display which adds the three colors. In contrast, hard copy images use the subtractive primary colors cyan, magenta, and yellow (CMY) plus, typically, black (K); so a printer represents a pixel as a quartet of intensities CMYK. Additionally, some ink jet printers have the capability of two different dye loads for the cyan and magenta colors, so a pixel would be represented by a sextuplet: CMYKLcLm where Lc and Lm are the low load cyan and magenta intensities, respectively.

U.S. Pat. No. 5,982,990 discloses methods of conversion an image representation as RGB to CMYKLcLm by use of conversion tables created by various control points and interpolations. In particular, tetrahedral interpolation may be used to convert from the RGB to CMYK or CMYKLcLm space. Such interpolation is also useful for 3-D-to-3-D color space conversion, for example from RGB to YCbCr (luminance, blue chrominance, red chrominance). A separate table is used to generate each of the 3/4/6 output colors from the input RGB color space. Typically, the table is 17×17×17 bytes/words for each output color; this corresponds to partitioning the RGB space into cubes by dividing each dimension by 16; then the number of vertices along each dimension is 17. For higher precision, the table can be 33×33×33 bytes/words.

The first step in any 3-D interpolation (there are essentially four kinds of interpolation: trilinear, prism, pyramid, and tetrahedral) is finding the cube that has control points (cube vertices) p(r₀, g₀, b₀) and p(r₁, g₁, b₁) as its diagonal where the point p(r, g, b) for which output colors are to be computed lies inside the cube. That is, where r₀≦r<r₁, g₀≦g<g₁, and b₀≦b<b₁. Trilinear interpolation uses the output color values at all the eight vertices of this cube to interpolate to obtain the required output color for the inside point. Prism interpolation cuts this cube into two parts and uses only six of the eight vertices, pyramidal interpolation cuts this cube in three parts and uses only five vertices, and tetrahedral interpolation cuts this cube into six parts (tetrahedra) and uses only four vertices. FIGS. 3a-3d illustrate representative ones of these interpolation volumes.

Tetrahedral interpolation is the most computationally simple of the four basic 3-D interpolation strategies, yet provides the best quality. Table 1 shows the relation between the relative location of the point, p(r, g, b), whose output value is being determined by interpolation and the corresponding tetrahedron in which it lies. In particular, the table uses Δx=(r−r₀)/(r₁−r₀), Δy=(g−g₀)/(g₁−g₀), Δz=(b−b₀)/(b₁−b₀). Each output color pixel (any one of C, M, Y, K, Lc, or Lm and generically denoted P) is computed as:

P(r,g,b)=P₀₀₀+c₁Δx+c₂Δy+c₃Δz,

and the coefficients c₁, c₂, and c₃ are computed as in Table 1. Normally the cubes are of the same size, so the vertices (control points) are evenly spaced. In other words:

r₁−r₀=g₁−g₀=b₁−b₀=cube_step

And the color value at a control point (cube vertex) is abbreviated by using subscripts:

$$\begin{matrix}P ( {r}_{0} , {g}_{0} , {b}_{0} ) = {P}_{000} , \\ P ( {r}_{1} , {g}_{0} , {b}_{0} ) = {P}_{100} , \\ ⋯ \\ P ( {r}_{1} , {g}_{1} , {b}_{1} ) = {P}_{111} .\end{matrix}$$

TABLE 1
The inequality relationships and the corresponding tetrahedron
plus coefficients for tetrahedral interpolation

| Tetrahedron | Test | C1 | C2 | C3 |
|---|---|---|---|---|
| T1 | Δx > Δy > Δz | P₁₀₀ − P₀₀₀ | P₁₁₀ − P₁₀₀ | P₁₁₁ − P₁₁₀ |
| T2 | Δx > Δz > Δy | P₁₀₀ − P₀₀₀ | P₁₁₁ − P₁₀₁ | P₁₀₁ − P₁₀₀ |
| T3 | Δz > Δx > Δy | P₁₀₁ − P₀₀₁ | P₁₁₁ − P₁₀₁ | P₀₀₁ − P₀₀₀ |
| T4 | Δy > Δx > Δz | P₁₁₀ − P₀₁₀ | P₀₁₀ − P₀₀₀ | P₁₁₁ − P₁₁₀ |
| T5 | Δy > Δz > Δx | P₁₁₁ − P₀₁₁ | P₀₁₀ − P₀₀₀ | P₀₁₁ − P₀₁₀ |
| T6 | Δz > Δy > Δx | P₁₁₁ − P₀₁₁ | P₀₁₁ − P₀₀₁ | P₀₀₁ − P₀₀₀ |

There are several possible ways to implement the test decision (tetrahedron selection) and thus compute c₁, c₂, and C₃. One may first collect the-pair-wise comparisons (Δx with Δy, Δx with Δz, and Δy with Δz) into a 3-bit index. This 3-bit index represents which tetrahedron the data point belongs to.

Next, there are two options:

(1) One may look up the 6 table offsets relative to P₀₀₀, and perform 7 lookups for P₀₀₀, C₁, C₂, and C₃.

(2) One may alternatively look up 4 table offsets, perform 4 lookups for the 4 vertices (e.g, for T3 lookup P₀₀₀, P₀₀₁, P₁₀₁, P₁₁₁), and perform some kind of matrix operation to combine the 4 vertices into c₁, c₂, and C₃. Since this 4×3 coefficient matrix, containing 0, +1, −1 values, depends on the test; it needs to be looked up as well. The matrix elements can be packed tightly to reduce computation time in the lookup, at expense of the computation for the unpacking. Although reducing lookups, this scheme is complicated and probably ends up costing more time.

However, there is considerable computation time to implement either option.

### SUMMARY OF THE INVENTION

The present invention provides a size sorting of interpolation differentials to limit table lookups in a color space conversion. Preferred embodiment color tables are partitioned into four banks for parallel access.

### BRIEF DESCRIPTION OF THE DRAWINGS

The drawings are heuristic for clarity.

FIG. 1 is a flow diagram.

FIG. 2 shows preferred embodiment hardware architecture.

FIGS. 3a-3d illustrate interpolation volumes.

### DESCRIPTION OF THE PREFERRED EMBODIMENTS

1. Overview

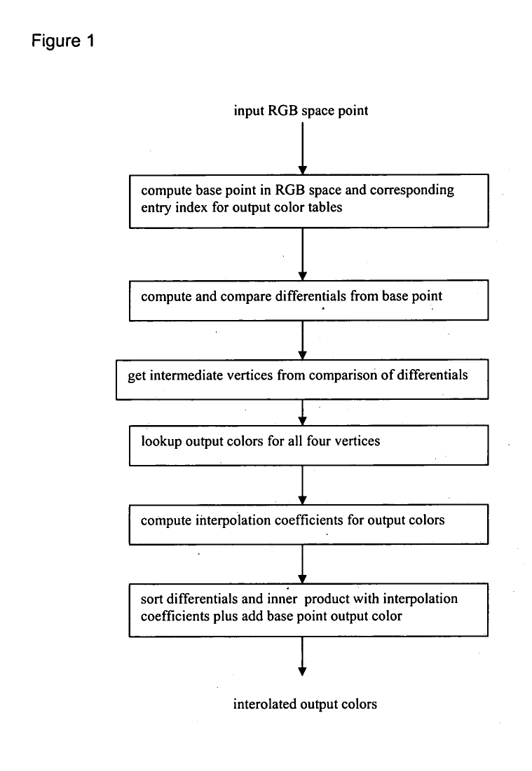

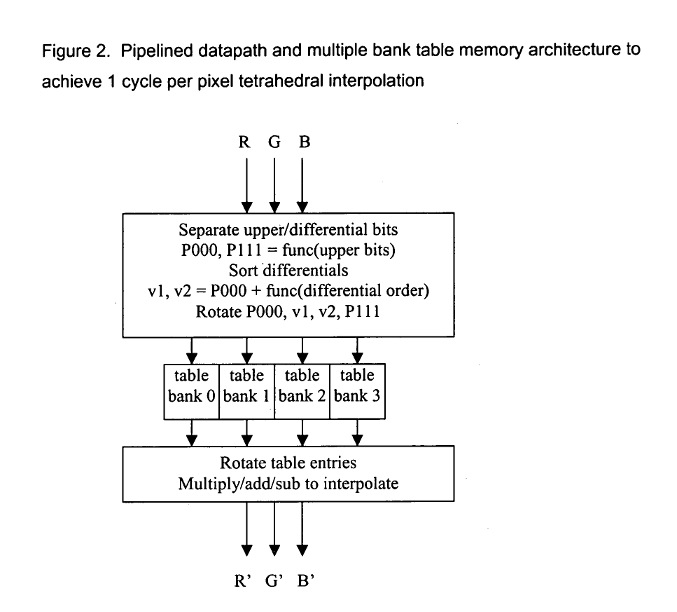

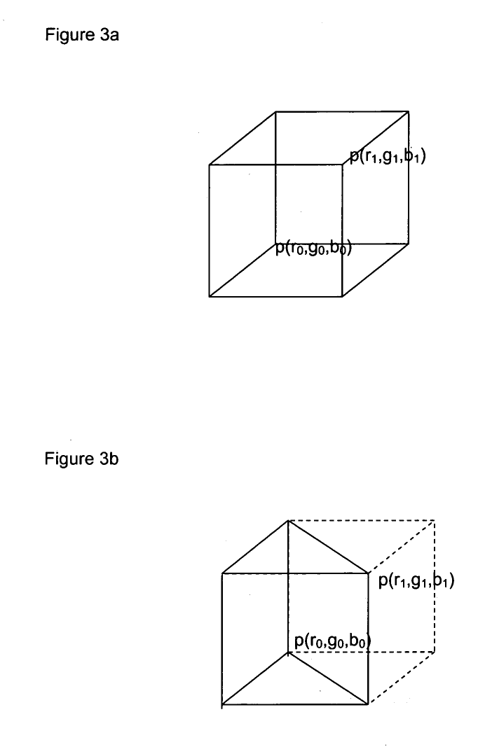

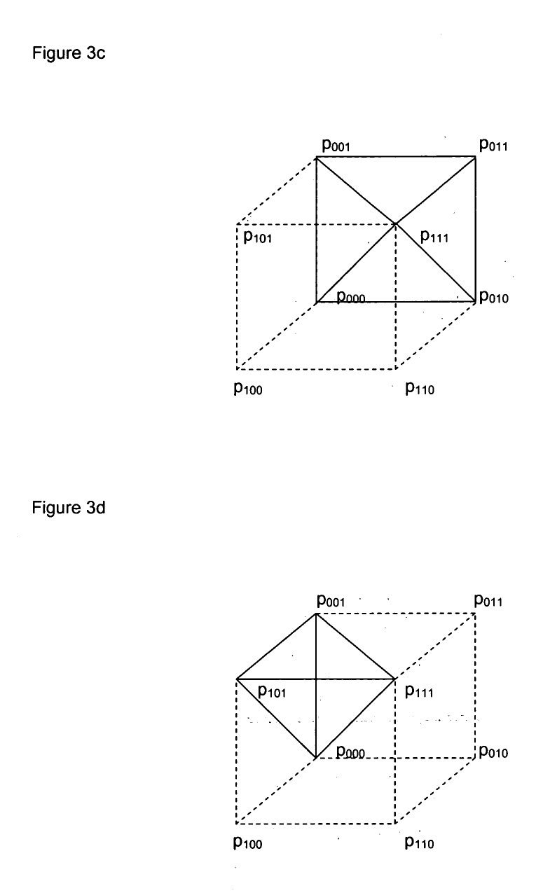

The preferred embodiment methods provide a reduced complexity version of tetrahedral interpolation by re-expressing the interpolation by sorting the differentials according to size; this can take advantage of parallel multiply-accumulate (MAC) units. Preferred embodiment hardware architecture adapts to the method with four memory banks and access rotation to reflect differential ordering. That is, the four vertices of the interpolation tetrahedron will correspond to the four memory banks on a rotating one-to-one basis. FIG. 1 is a method flow diagram, and FIG. 2 shows the hardware.

2. Interpolation Method

The first preferred embodiment methods provide a sorting-based approach to look up just the 4 relevant tetrahedron vertices for each pixel, and does not rely on complicated lookup or unpacking/matrixing. First, the interpolation coefficients (c₁, C₂, c₃) can be reordered according to the order of the corresponding differentials (Δx; Δy, Δz).

TABLE 2
Coefficients and order of differentials

| | | max | middle | min |
|---|---|---|---|---|
| | | differential | differential | differential |
| Tetra- | | and its | and its | and its |
| hedron | Test | coefficient | coefficient | coefficient |
| T1 | Δx > Δy > Δz | Δx, | Δy, | Δz, |
| | | P₁₀₀ − P₀₀₀ | P₁₁₀ − P₁₀₀ | P₁₁₁ − P₁₁₀ |
| T2 | Δx > Δz > Δy | Δx, | Δz, | Δy, |
| | | P₁₀₀ − P₀₀₀ | P₁₀₁ − P₁₀₀ | P₁₁₁ − P₁₀₁ |
| T3 | Δz > Δx > Δy | Δz, | Δx, | Δy, |
| | | P₀₀₁ − P₀₀₀ | P₁₀₁ − P₀₀₁ | P₁₁₁ − P₁₀₁ |
| T4 | Δy > Δx > Δz | Δy, | Δx, | Δz, |
| | | P₀₁₀ − P₀₀₀ | P₁₁₀ − P₀₁₀ | P₁₁₁ − P₁₁₀ |
| T5 | Δy > Δz > Δx | Δy, | Δz, | Δx, |
| | | P₀₁₀ − P₀₀₀ | P₀₁₁ − P₀₁₀ | P₁₁₁ − P₀₁₁ |
| T6 | Δz > Δy > Δx | Δz, | Δy, | Δx, |
| | | P₀₀₁ − P₀₀₀ | P₀₁₁ − P₀₀₁ | P₁₁₁ − P₀₁₁ |

Thus, the interpolation equation can be re-written as

P(r,g,b)=P₀₀₀+(P(v₁)−P₀₀₀)*max_{—}diff+(P(v₂−P(v₁))*mid_{—}diff+(P₁₁₁−P(v₂))*min_diff

where v₁, v₂ are the two vertices of the tetrahedron other than the diagonal ends, p₀₀₀ and p₁₁₁, with v₁ corresponds to the vertex in the direction of the largest differential from the base point vertex, p₀₀₀.

Thus, instead of looking up the index and output color value of six vertices, and the value of P₀₀₀, we need only look up the index of the two intermediate vertices, v₁ and v₂, and the output color value of 4 vertices, P₀₀₀, V₁, V₂, p₁₁₁. This reduces the number of lookups from thirteen in the straightforward implementation to just six in the preferred embodiment method.

Following Table 3 lists steps illustrative of an implement the tetrahedral interpolation on a processor with parallel multiply-accumulate units (MACs). In particular, the processor cycle count for both 4-MAC and 8-MAC capabilities are presented. In many steps, the allocation of the data structures (whether the data structures are in data memory or in coefficient memory) affects computation time. Worst-case scenarios are used to arrive at conservative estimates. Presume R, G, and B values each in the range 0 to 255 and presume a partitioning of the RGB color space into cubes of edge length 16 for the interpolation, so each range 0 to 255 is partitioned into 16 intervals. Thus there are 17×17×17 cube vertices (base points/control points), and the cube of an input RGB point can be found simply by looking at the 4 most significant bits of each input color (step 1a). Step 1b computes the address of this base point (“Base”) in a 17×17×17-entry lookup table of output color.

Step 2 computes the three directional differentials of the interpolation point from the base point by looking at the 4 least significant bits of each input color value.

Step 3 compares the differentials and computes a test index which indicates which of the six tetrahedra applies; this could be a 3-bit index.

Step 4 uses the test index of step 3 to find the offsets from the base point address for the two intermediate vertices to use as addresses in the 17×17×17 output color table; for example, in T3 the offset for v₁ is 17*17 because v₁=p₀₀₁ and blue input increments are separated by address offsets of 17*17 in the lookup table. Similarly; the offset for v₂ is 17*17+1 because V₂=p₁₀₁ and red increments are separated by address offsets of 1. (This test index lookup table has six entries with each entry the pair of offsets.) Step 5 adds the two address offsets from step 4 to the base point address from step 1 to yield the addresses for v₁ and v₂ in the 17×17×17 output color table; the fourth vertex always has the address offset 17*17+17+1 from the base point, so the address computation can be absorbed into the lookup. Step 6 looks up the four tetrahedron vertex output color values (e.g., P₀₀₀, P₀₀₁, P₁₀₁, P₁₁₁, for T3) in the 17×17×17 output color lookup table. Step 7 computes Cmax=(P(v₁)−P₀₀₀), Cmid=(P(v₂)−P(v₁)), Cmin=(P₁₁₁−P(V₂)) from the results of step 6. Step 8 sorts the differentials in size order: Dmax is the largest (i.e., Δz for T3), Cmid is the middle (i.e., Δx for T3), and Cmin is the smallest (i.e., Δy for T3). Lastly, step 9 computes the interpolated output color as the sum of an inner product of the ordered coefficients and the ordered differentials, Cmax*Dmax+Cmid*Dmid+Cmin*Dmin, plus the base point output color value P₀₀₀.

TABLE 3
Procedure for the efficient tetrahedral interpolation
scheme on the image accelerator of a DM320 processor

| | | | Cycles per |
|---|---|---|---|
| | | | data point |
| Step | Sub- | | 4-mac:8-mac |
| # | step | Description | (:DM320) |
| 1 | | Step 1 compute-saturates R[7:4] & | |
| | | G[7:4] & B[7:4], and compute the | |
| | | cube base point (there are 17 × | |
| | | 17 × 17 cube base points) | |
| | (a) | Compute [Rbase Gbase Bbase] = | 6/4:6/8 |
| | | [R G B] & 0xF0 | |
| | (b) | Compute Base = Rbase + Gbase*17 + | 4/4:4/8 |
| | | Bbase*17*17, with 3-tap vertical | |
| | | filter | |
| 2 | | Compute the differentials Δx, Δy, | 6/4:6/8 |
| | | and Δz [Δx Δy Δz] = [R G B] | |
| | | & 0x0F | |
| 3 | | Compare the differentials and gen- | |
| | | erate the composite test index for | |
| | | decision making | |
| | (a) | Compute Δx ≧ Δy -> Δx − Δy and | 3/4:3/8 |
| | | saturate answer to either a 1 or | |
| | | a 0 | |
| | (b) | Compute Δy ≧ Δz -> Δy − Δz and | 3/4:3/8 |
| | | saturate answer to either a 1 or | |
| | | a 0 | |
| | (c) | Compute Δx ≧ Δz -> Δx − Δz and | 3/4:3/8 |
| | | saturate answer to either a 1 or | |
| | | a 0 | |
| | (d) | Weighted sum of (a), (b), (c), with | 4/4:4/8 |
| | | 3-tap vertical filter | |
| 4 | | Do a lookup with step (3) to get | 4/4:6/8: |
| | | offsets for v1 and v2 | 4/4 |
| 5 | | Add results of step (1) to step (4) | 6/4:6/8 |
| | | to get addresses for the first 3 | |
| | | vertices for each pixel. The last | |
| | | vertices has fixed offset to the | |
| | | first, so can address calculation | |
| | | can be absorbed into the lookup | |
| | | operation. | |
| 6 | | Look up the 4 vertices, assume | 8:36/8:8 |
| | | single table | |
| 7 | | Compute Cmax, Cmid, and Cmin | 9/4:9/8 |
| | | from step (6) | |
| 8 | | Sort the differentials Δx, Δy, and | |
| | | Δz | |
| | (a) | Find Dmax | 4/4:4/8 |
| | (b) | Find Dmin | 4/4:4/8 |
| | (c) | Find Dmid, for DM270/DM310, mid = | 8/4:8/8: |
| | | sum − max − min; for DM320, | 4/8 |
| | | mid is found with median filter | |
| | | hardware in 4/4 cycles | |
| 9 | | Compute the color pixel | |
| | (a) | Compute Cmax*Dmax + Cmid*Dmid + | 4/4:4/8 |
| | | Cmin*Dmin with innerproduct | |
| | | operation | |
| | (b) | Add P₀₀₀ | 3/4:3/8 |

The total time taken on a 4-MAC setup to perform tetrahedral interpolation generating one color is 25.75 cycles per pixel; so adding 10% overhead yields total of 28.3 cycles per color component.

If the memory allocation can have all tables resident in memory, this can eliminate duplicate computation steps among the output colors. Only steps 6, 7, and 9 need to be performed for a subsequent color, totaling 12 cycles; which yields 13.2 cycles per point after adding 10% overhead. So 3-color conversion takes 54.7 cycles per pixel. 4-color conversion takes 67.9 cycles per pixel, and 6-color conversion takes 94.3 cycles per pixel.

The total time taken on the 0.8-MAC DM320 accelerator to perform tetrahedral interpolation for generating one color is 13.625 cycles per pixel; or 16.4 cycles per color component when including 20% overhead. (Higher overhead is observed due to longer hardware pipeline and faster compute time.) With the tables residing in memory, each subsequent component takes 6.5 cycles and adding 20% overhead to total 7.8 cycles, and we can process 3-color conversion in 32 cycles per pixel. 4-color conversion takes 39.8 cycles per pixel. 6-color conversion takes 55.4 cycles per pixel.

The DM320 spends 0.25 cycle more in step 2, 8−36/8=3.5 cycles more in step 6, and saves 0.5 cycle in step 8c. The total time is 16.875 cycles per pixel; and adding 20% overhead gives a total of 20.25 cycles per color component. Steps 6, 7, and 9 total 10 cycles per pixel; so adding 20% overhead yields 12 cycles per subsequent color component.

The straightforward implementation would cost about 20 cycles per pixel on DM310 before overhead. Thus this preferred embodiment method using the ordered differentials and coefficients is about 30% faster.

Note that we can also save some intermediate results so that even if we have to process the output colors in separate passes, the subsequent passes can make use of available results. What we save and reuse is a tradeoff between computation time, memory transfer time, and memory bandwidth. For, example in DM310, we can save table base, test index, Dmax, Dmid, and Dmin, and spend just 8 (9.6 with 20% overhead) cycles per subsequent component (steps 4, 5, 6, 7, 9). The intermediate results should pack into 6 bytes. The transfer time and the computation time approximately balance out, so we are close to the optimal performance.

For printer applications on DM310 running at 200 MHz, this has the following cases:

For a 4-color printing system, on a 3 MegaPixel image, RGB to CMYK takes 3M*(16.4+3*9.6)/200 MHz=0.68 second

For a 6-color printing system, on a 3 MegaPixel image, RGB to CMYKLcLm takes 3M*(16.4+5*9.6)/200 MHz=0.97 second

For a 4-MAC iMX, steps 4, 5, 6, 7 and 9 total 14.5 cycles (15.95 cycles with 10% overhead) per subsequent component. For DM320, steps 4, 5, 6, 7, and 9 total 11.75 cycles (14.1 cycles with 20% overhead) per subsequent component.

3. Lookup Table Architecture

With the preferred embodiment methods, preferred embodiment hardware achieves a one-cycle-per-pixel computation rate for tetrahedral interpolation.

Using the order of the differentials, reduce the number of table lookups to 4 and streamline the interpolation process. Four lookups are required per output color plane. The usual transform is from 3 colors to 3, 4, or 6 colors; For example, 3 output color planes requires performance of 3*4=12 lookups.

First, note that the 4 vertices are determined using differentials of input color components; if we perform 12 lookups, we will be accessing:

table_red[p₀₀₀], table_red[v₁], table_red[v₂], table_red[p₁₁₁],

table_green[p₀₀₀], table_green[v₁], table_green[v₂], table_green[p₁₁₁],

table_blue[p₀₀₀], table_blue[v₁], table_blue[v₂], table blue[p₁₁₁]

The preferred embodiment hardware architecture (see FIG. 2) conveniently combines tables for output color planes into one wide table. For example, 3 colors into a 32-bit word so that we can fit 10-bit outputs, 6 colors into a 64-bit word, or 4 colors into a 32-bit word with 8 bits per output. Thus, we reduce from 12, 16, or 24 lookups to just 4 lookups as long as we structure our table width according to number of output planes and entry size. Next, note that there is a relationship among the lookup table addresses of the 4 vertices being accessed. Indeed, the address of v₁ is one of three possibilities:

&P₀₀₁=&P₀₀₀+1

&P₀₁₀=&P₀₀₀+17

&P₁₀₀=&P₀₀₀+17²

where & is the address operator. The address of v₂ is one of three possibilities:

&P₀₁₁=&P₀₀₀+1+17

&P₁₀₁=&P₀₀₀+1+17²

&P₁₁₀=&P₀₀₀+17+17²

Note that the subscript ordering been reversed, the first component is blue rather than red.

Furthermore, the address of P₁₁₁ is: &P₁₁₁=&P₀₀₀+1+17+17² But 17 mod 4=1, and 17² mod 4=1. Therefore, let b=&P₀₀₀ mod 4, then

&P(v₁)=(b+1)mod 4

&P(v₂)=(b+2) mod 4

&P₁₁₁=(b+3)mod 4

The above implies a memory with 4 banks, in which each bank provides the multiple output color components wanted, the 4 lookups being performed will avoid each other and fall into different banks.

For example, if the lookup table address of P₀₀₀ is &P₂₀₀=2 mod 4, then

&P(v₁)=3 mod 4

&P(v₂)=0 mod 4

&P₁₁₁=1 mod 4

The preferred embodiments also structure input and output memory so that input/output does not become a bottleneck. The table need for lookup can be structured so that all 4 vertex lookups can be performed in the same clock cycle. The computation required is purely spatially independent, so can be pipelined to necessary depth to provide desired performance. Ultimately, we can achieve one clock cycle per pixel for tetrahedral interpolation, if we are willing to pay for the datapath pipeline and parallel table paths. FIG. 2 shows a hardware diagram for an example of a preferred embodiment 3-color-to-3-color converter circuit. In particular, the lookup table is partitioned into 4 memory banks corresponding to residues mod 4 of the vertices. Thus aligning p₀₀₀, v₁, v₂, p₁₁₁, with their corresponding memory banks is simply a rotation, and all four output values can be read simultaneously. For example, if the base point vertex p₀₀₀=[14,3,6] and tetrahedron T3 is used, then v₁=[14,3,7], V₂=[15,3,7], and the cube diagonal endpoint p₁₁₁=[15,4,7]. Thus the lookup table address of the base point is Base=14+3*17+6*17*17=1799, and the corresponding table addresses for v₁, V₂, and p₁₁₁ are, respectively, 2088, 2089, and 2106. Thus the four addresses for p₀₀₀, v₁, v₂, p₁₁₁ are, respectively, 3, 0, 1, 2 mod 4. Hence, simultaneously look up output values P₀₀₀ for p₀₀₀ in bank3, P₀₀₁ for v₁ in bank0, P₁₀₁ for v₂ in bank1, and P₁₁₁ for p₁₁₁ in bank2.

4. Modifications

There are various modifications and variations of the preferred embodiments which maintain the feature of ordered differentials.

More generally, the RGB space could be higher precision (more bits per colorr) and could be partitioned by a factor of 2ⁿ in each dimension, then the number of cube vertices will be (2ⁿ+1)×(2ⁿ+1)×(2ⁿ+1) and thus p₀₀₀, v₁, v₂, p₁₁₁ will again all differ modulo 4 (provided n is at least 2) because (2ⁿ+1)=1 mod4 and (2ⁿ+1)*(2ⁿ+1)=1 mod4. This means that the same four-bank memory for the output colors table can be used to avoid a lookup bottleneck. The computations would essentially be unchanged except for scale: Base=Rbase+Gbase*(2ⁿ+1)+Bbase*(2ⁿ+1)*(2ⁿ+1), and so forth.

Of course, the R, G, and B could be permuted in the formulas.

The number of base points as 16×16×16 suffices in that the base point is the vertex with the lowest index values of the vertices of a cube.

What is claimed is:

1. A method of tetrahedral interpolation, comprising the steps of:
(a) receive a color space input point;
(b) compute a base point and three differentials for said input point;
(c) compare said three differentials;
(d) compute tetrahedron vertices from the results of steps (b) and (c), a first one of said vertices being said base point;
(e) find output values for each of said vertices;
(f) compute an interpolated output value for said input point as the sum of the output value of said base point plus the inner product of said differentials in size order with corresponding differences of said output values for said vertices.

2. The method of claim 1, wherein:
(a) said output values of step (e) are a single color value for each vertex.

3. The method of claim 1, wherein:
(a) said output values of step (e) are three color values for each vertex.

4. The method of claim 1, wherein:
(a) said output values of step (e) are four color values for each vertex.

5. The method of claim 1, wherein:
(a),said output values of step (e) are six color values for each vertex.

6. A tetrahedral interpolation system, comprising:
(a) an input for receiving an input point;
(b) first circuitry coupled to said input and arranged to output a base point plus three differentials for said input point, said differentials sorted in size order;
(c) second circuitry coupled to an output of said first circuitry and to compute lookup table addresses of four vertices of an interpolation tetrahedral for said input point;
(d) four memory banks containing said lookup table and coupled to said second circuitry, wherein each of said memory banks contains entries for all addresses with a common residue modulo 4; and
(e) third circuitry coupled to said four memory banks and said first circuitry, said third circuitry arranged to compute a tetrahedral interpolation value for said input point.
